(19) United States
(12) Patent Application Publication
(10) Pub. No.: US 2026/0328933 A1
(43) Pub. Date: Oct. 22, 2026

(54) METHOD FOR RECONSTRUCTING OCEAN SURFACE VECTOR CURRENTS BASED ON SPACEBORNE SYNTHETIC APERTURE RADAR

(71) Applicant: Sanya Oceanographic Laboratory, Sanya City (CN)

(72) Inventors: Biao ZHANG, Sanya City (CN); Shengren FAN, Sanya City (CN); Yijun HE, Sanya City (CN); Xingwei JIANG, Sanya City (CN)

(21) Appl. No.: 19/542,606

(22) Filed: Feb. 17, 2026

(30) Foreign Application Priority Data
Apr. 2, 2025 (CN) 202510405566.0

(51) Int. Cl. G01S 13/90; G01C 13/00; G01S 13/64

(52) U.S. Cl. CPC G01S 13/90; G01C 13/006; G01S 13/64

(57) ABSTRACT

The present application provides a method for reconstructing ocean surface vector currents based on a spaceborne synthetic aperture radar, relating to the field of ocean current observation. The method includes: acquiring a synthetic aperture radar image of a research region; determining a radial ocean surface current velocity according to the synthetic aperture radar image; determining an initial azimuthal current velocity based on a geostrophic approximation theory and the radial ocean surface current velocity; performing ageostrophic correction on the initial azimuthal current velocity to obtain a final azimuthal current velocity; and reconstructing an ocean surface vector current field according to the radial ocean surface current velocity and the final azimuthal current velocity so as to obtain a current velocity magnitude and a current direction of the reconstructed ocean surface vector current field.

### CROSS REFERENCE TO RELATED APPLICATION

This patent application claims the benefit and priority of Chinese Patent Application No. 2025104055660.0, filed with the China National Intellectual Property Administration on Apr. 2, 2025, the disclosure of which is incorporated by reference herein in its entirety as part of the present application.

### TECHNICAL FIELD

The present application relates to the field of ocean current observation, and in particular, to a method for reconstructing ocean surface vector currents based on a spaceborne synthetic aperture radar on the basis of geostrophic approximation and ageostrophic correction.

### BACKGROUND

Ocean currents, a complex system composed of various dynamic elements, include geostrophic currents, wind-driven Ekman currents, wave-induced Stokes drift, inertial motion, tidal currents, and the like. These ocean currents play a crucial role in the global redistribution and exchange of oceanic heat, salt, nutrients, carbon sinks, and freshwater. They significantly influence oceanic dynamic phenomena. Furthermore, in-depth research on ocean currents has significant application value and practical significance for optimizing ship route planning, precisely developing fishery resources, efficiently conducting maritime search and rescue operations, and effectively tracking pollutant diffusion paths.

With the rapid development of the satellite remote sensing technology, satellites equipped with altimeters have become vital tools for mapping global ocean surface current fields. A spaceborne synthetic aperture radar (SAR) possesses the capability of all-day, all-weather global ocean observation, and can provide high-resolution (1 km) and wide-coverage (500 km) ocean surface Doppler shift data. However, most currently operational SAR satellites in orbit are equipped with single antennas, and thus can only acquire one component of ocean surface currents, namely a radial current velocity along an antenna direction, without directly measuring an azimuthal current velocity along the flight direction of the satellites. Nevertheless, in oceanographic research and applications, an ocean surface current velocity is a more desirable form of data. Consequently, how to reconstruct ocean surface current velocity vectors from single-antenna SAR data is a key technical challenge for improving the accuracy of numerical model forecasting.

### SUMMARY

An objective of the present application is to provide a method for reconstructing ocean surface vector currents based on a spaceborne synthetic aperture radar that can obtain an ocean surface vector current field from a single-antenna SAR and improve the accuracy of the ocean surface vector current field.

In order to achieve the above objective, the present application provides the following technical solutions.

The present application provides a method for reconstructing ocean surface vector currents based on a spaceborne synthetic aperture radar, including:
acquiring a synthetic aperture radar image of a research region;
determining a radial ocean surface current velocity according to the synthetic aperture radar image;
determining an initial azimuthal current velocity based on a geostrophic approximation theory and the radial ocean surface current velocity;
performing ageostrophic correction on the initial azimuthal current velocity to obtain a final azimuthal current velocity; and
reconstructing an ocean surface vector current field according to the radial ocean surface current velocity and the final azimuthal current velocity so as to obtain a current velocity magnitude and a current direction of the reconstructed ocean surface vector current field.

According to specific embodiments provided in the present application, the present application has the following technical effects.

The present application provides a method for reconstructing ocean surface vector currents based on a spaceborne synthetic aperture radar, which takes full advantage of the physical oceanography theory. The method is to first determine the initial azimuthal current velocity based on the geostrophic approximation theory and the radial ocean surface current velocity and then perform ageostrophic correction on the initial azimuthal current velocity, improving the accuracy of the azimuthal current velocity, and further to reconstruct the ocean surface vector current field according to the radial ocean surface current velocity and the final azimuthal current velocity. This allows for accurately obtaining the ocean surface vector current field from the single-antenna SAR and improving the accuracy of the ocean surface vector current field.

### BRIEF DESCRIPTION OF THE DRAWINGS

To describe the technical solutions in the embodiments of the present application or in the related art more clearly, the following briefly describes the accompanying drawings required for describing the embodiments or the related art. Apparently, the accompanying drawings in the following description show some embodiments of the present application, and a person of ordinary skill in the art may still derive other accompanying drawings from these accompanying drawings without creative efforts.

FIG. 1 is a diagram showing an environment in which a method for reconstructing ocean surface vector currents based on a spaceborne synthetic aperture radar according to an embodiment of the present application;

FIG. 2 is a schematic flowchart of a method for reconstructing ocean surface vector currents based on a spaceborne synthetic aperture radar provided by an embodiment of the present application;

FIG. 3 is a schematic diagram of functional modules of a device for reconstructing ocean surface vector currents based on a spaceborne synthetic aperture radar provided by an embodiment of the present application; and

FIG. 4 is a schematic structural diagram of a computer device provided by an embodiment of the present application.

### DETAILED DESCRIPTION OF THE EMBODIMENTS

The technical solutions in the embodiments of the present application are clearly and completely described below with reference to the drawings in the embodiments of the present application. Apparently, the described embodiments are only some rather than all of the embodiments of the present application. All other embodiments obtained by a person of ordinary skill in the art based on the embodiments of the present application without creative efforts shall fall within the protection scope of the present application.

To make the above objects, features, and advantages of the present application more obvious and easier to understand, the present application will be further described in detail with reference to the accompanying drawings and the detailed description.

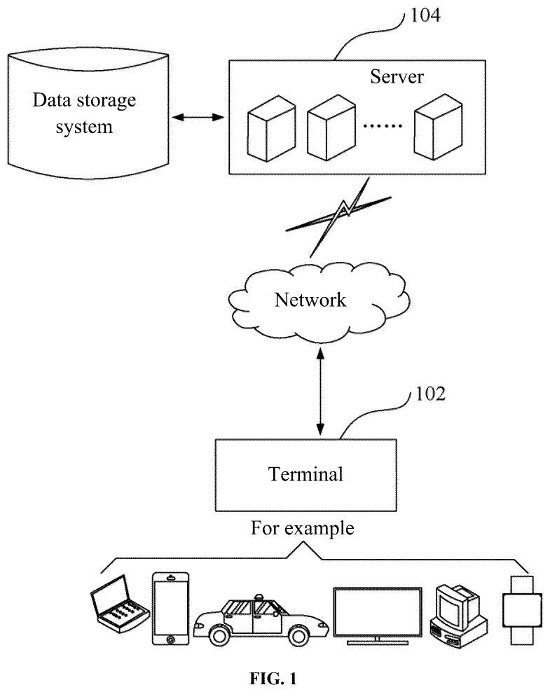

A method for reconstructing ocean surface vector currents based on a spaceborne synthetic aperture radar provided by an embodiment of the present application may be applied to the environment as shown in FIG. 1. A terminal 102 communicates with a server 104 over a network. A data storage system may store data that need to be processed by the server 104. The data storage system may be arranged separately, or integrated with the server 104, or disposed on cloud or other servers. The terminal 102 may send a synthetic aperture radar image of a research region to the server 104, and the server 104 may reconstruct an ocean surface vector current field after receiving the synthetic aperture radar image of the research region. The server 104 may feed back the reconstructed ocean surface vector current field to the terminal 102. Furthermore, in some embodiments, the method for reconstructing ocean surface vector currents based on a spaceborne synthetic aperture radar may be implemented solely by the server 104 or the terminal 102.

The terminal 102 may be, but not limited to, various desktop computers, laptop computers, smartphones, tablet computers, Internet-of-Things devices, and portable wearable devices. The Internet-of-Things devices may be smart speakers, smart televisions, smart air conditioners, smart vehicular devices, etc. The portable wearable devices may be smart watches, smart bracelets, headset devices, etc. The server 104 can be implemented by a standalone server or a server cluster made up of a plurality of servers, or may be a cloud server.

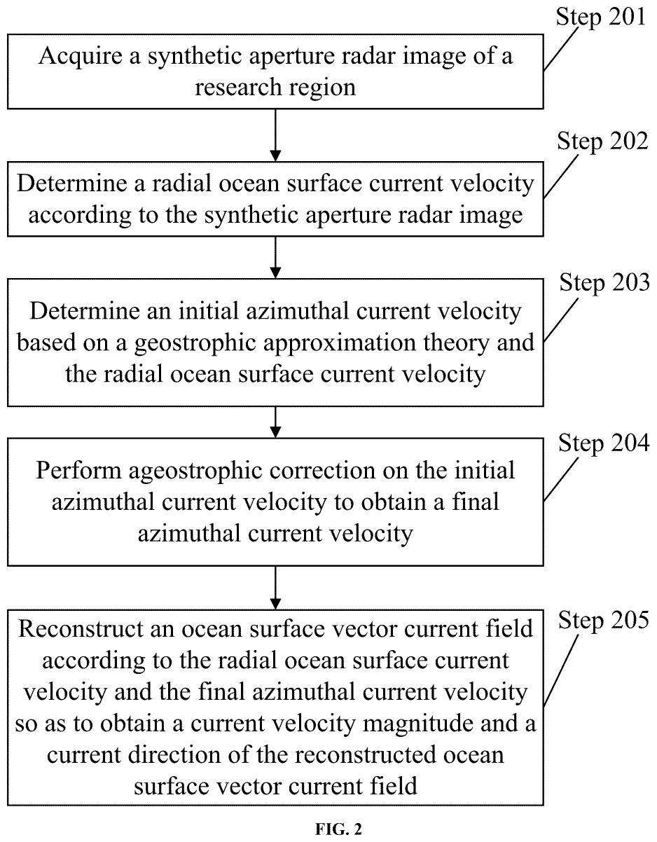

In an exemplary embodiment, as shown in FIG. 2, provided is a method for reconstructing ocean surface vector currents based on a spaceborne synthetic aperture radar. This method is performed by a computer device, and may particularly be performed solely by a computer device such as a terminal or a server, or performed jointly by a terminal and a server. In an embodiment of the present application, this method is applied to the server 104 of FIG. 1 for example, and includes the following step 201 to step 205.

In step 201, a synthetic aperture radar image of a research region is acquired. The synthetic aperture radar image includes Doppler shifts of the ocean surface.

In a particular application example, the Doppler shifts of the ocean surface are measured by the spaceborne synthetic aperture radar to generate the synthetic aperture radar image.

In step 202, a radial ocean surface current velocity is determined according to the synthetic aperture radar image.

In a particular application example, the Doppler shifts observed by the radar include a non-geophysical Doppler shift and a geophysical Doppler shift, where the geophysical Doppler shift is induced by ocean currents and wave motion. In order to extract the ocean current-induced Doppler shift f_{osc}, the non-geophysical Doppler shift and the wave motion-induced Doppler shift among the Doppler shifts of the ocean surface are corrected to obtain the ocean current-induced Doppler shift. The non-geophysical Doppler shift may be corrected with a non-zero Doppler shift over land in combination with a linear fitting method, while the wave motion-induced Doppler shift may be corrected with a semi-empirical Doppler velocity model.

The radial ocean surface current velocity is determined by a formula

$$u = - \frac{π {f}_{o s c}}{{k}_{r} sin ( θ )}$$

according to the ocean current-induced Doppler shift, where u represents the radial ocean surface current velocity with a spatial resolution of 1 km; f_{osc} represents the ocean current-induced Doppler shift; kᵣ represents a wavenumber of an incident electromagnetic wave; and θ represents a radar incidence angle. Both kᵣ and θ are known parameters.

In step 203, an initial azimuthal current velocity is determined based on a geostrophic approximation theory and the radial ocean surface current velocity.

In a particular application example, it is assumed that the ocean surface currents are quasi-geostrophic and the surface currents are geostrophic currents. Since the geostrophic currents are non-divergent (∂u/∂x+∂v/∂y=0) and the radial ocean surface current velocity u has been obtained in step 202, the initial azimuthal current velocity may be determined by the following formula (1):

$${v}_{0} = {v}_{L} - {\int }_{{y}_{L}}^{y} \frac{\partial u}{\partial x} dy \qquad ( 1 )$$

where v₀ represents the initial azimuthal current velocity; v_{L} represents an azimuthal current velocity at a lower ocean boundary in the synthetic aperture radar image; y_{L} represents a y-axis coordinate of the lower ocean boundary in the synthetic aperture radar image; u represents the radial ocean surface current velocity; x and y represent coordinates in a rectangular coordinate system; and the x-axis represents a radial direction, i.e., the antenna pointing, while the y-axis represents an azimuthal direction, i.e., the flight direction of the satellite.

The initial azimuthal current velocity at the position (x, y) may be particularly obtained by the following formula (2):

$${v}_{0} ( x , y ) = {v}_{L} ( x ) - {\int }_{{y}_{L}}^{y} \frac{\partial }{\partial x} u ( x , y ) d y \qquad ( 2 )$$

where v₀(x, y) represents the initial azimuthal current velocity at the position (x, y); v_{L}(x)=v(x, y_{L}) represents the azimuthal current velocity at a lower ocean boundary (x, y_{L}) in the synthetic aperture radar image, and this unknown variable may be obtained by the Global High-Resolution Real-Time Forecasting System of the Copernicus Marine Environment Monitoring Service (CMEMS); and u(x, y) represents the radial ocean surface current velocity at the position (x, y).

In step 204, ageostrophic correction is performed on the initial azimuthal current velocity to obtain a final azimuthal current velocity.

In a particular application example, the ocean surface currents are not strictly geostrophic but also contain ageostrophic components. Therefore, it is necessary to calculate the ageostrophic currents to compensate the initial azimuthal current velocity. Step 204 includes the following steps 41 and 42.

In step 41, an ageostrophic current is determined according to the initial azimuthal current velocity using a surface horizontal momentum equation. The surface horizontal momentum equation is expressed as a formula (3) and a formula (4):

$$\frac{d u}{dt} - fv = - g \frac{\partial ξ}{\partial x} + \frac{\partial }{\partial z} {A}_{z} \frac{\partial u}{\partial z} \qquad ( 3 )$$

$$\frac{d v}{dt} - fu = - g \frac{\partial ξ}{\partial y} + \frac{\partial }{\partial z} {A}_{z} \frac{\partial v}{\partial z} \qquad ( 4 )$$

where v represents the final azimuthal current velocity; t represents a time; f represents the Coriolis force; g represents the gravitational acceleration; ξ represents an ocean surface height; A_{z} represents a turbulent eddy viscosity coefficient; and z represents an ocean depth.

The vertical component of the vorticity of the ocean surface currents may be obtained by calculating the curl of the formula (3) and the formula (4), as shown in formula (5):

$$\frac{d ω}{dt} + ( f + ω ) D = \frac{\partial }{\partial z} {A}_{z} \frac{\partial ω}{\partial z} \qquad ( 5 )$$

where ω represents the vorticity of the final ocean surface currents, ω=∂v/∂x−∂u/∂y; and D represents the divergence of the ocean surface currents, D=∂u/∂x+∂v/∂y.

It should be noted that

$$\frac{\partial }{\partial z} {A}_{z} \frac{\partial u}{\partial z}$$

on the right side of the equal sign in the formula (3),

$$\frac{\partial }{\partial z} {A}_{z} \frac{\partial v}{\partial z}$$

on the right side of the equal sign in the formula (4), and

$$\frac{\partial }{\partial z} {A}_{z} \frac{\partial ω}{\partial z}$$

on the right side of the equal sign in the formula (5) represent wind-driven currents, and a velocity of the wind-driven currents is approximately 2% of the wind velocity. Thus, a wind velocity of 5 m/s induces a current velocity of about 0.1 m/s. The magnitude of mesoscale ocean currents is approximately 1 to 2 m/s. Given that the magnitude of the wind-driven currents is relatively small, the influence of the wind-driven currents is not considered in the present application.

Assuming that the ageostrophic current velocity is significantly smaller than the geostrophic current velocity, the formula (5) is linearized to obtain the expression form of a formula (6):

$$\frac{\partial }{\partial y} δ v = - \frac{1}{( f + {ω}_{0} )} \frac{d {ω}_{0}}{dt} \qquad ( 6 )$$

where δv represents the ageostrophic current; ω₀ represents the vorticity of the ocean surface currents, ω₀=∂v₀/∂x−∂u/∂y, and the formula (2) is substituted into ω₀ to derive a formula (7):

$${ω}_{0} = \frac{\partial }{\partial y} {v}_{L} ( x ) - \frac{\partial }{\partial y} u ( x , y ) - {\int }_{{y}_{L}}^{y} \frac{{\partial }^{2}}{\partial {x}^{2}} u ( x , y ) dy \qquad ( 7 )$$

When estimating the ageostrophic currents using the formula (6) and the formula (7), information on the vorticity changing over time is required. However, since SAR observations are instantaneous, such information cannot be obtained. In the present application, an adjustment parameter |ω₀(x, y)|J/(fτ) is adopted to replace the term on the right side of the equal sign in the formula (6), where ω₀(x, y) represents the vorticity of the ocean surface current at the position (x, y), and τ represents the time adjustment parameter. The formula (6) may be solved to obtain the ageostrophic current, as shown in a formula 8):

$$δ v = \frac{1}{f τ} {\int }_{{y}_{L}}^{y} \vert {ω}_{0} \vert dy \qquad ( 8 )$$

In order to eliminate the time adjustment parameter τ, by combining the formula (2) and the formula (8), the expression related to r is as shown in a formula (9):

$$\frac{1}{f τ} = \frac{( {v}_{U} - {v}_{L} ) + {\int }_{{y}_{L}}^{{y}_{U}} ( \frac{\partial u}{\partial x} ) dy}{{\int }_{{y}_{L}}^{{y}_{U}} \vert {ω}_{0} \vert dy} \qquad ( 9 )$$

where v_{U} represents the azimuthal current velocity at the upper ocean boundary in the synthetic aperture radar image, which may be calculated with the direction of a coastal current in combination with the radial ocean surface current velocity u; v_{L} represents the azimuthal current velocity at the lower ocean boundary in the synthetic aperture radar image, which is provided by the CMEMS; and y_{U} represents the y-axis coordinate of the upper ocean boundary in the synthetic aperture radar image.

The formula (9) is substituted into the formula (8) to obtain the final expression of the ageostrophic current δv, as shown in a formula (10):

$$δ v = [ ( {v}_{U} - {v}_{L} ) + {\int }_{{y}_{L}}^{{y}_{U}} ( \frac{\partial u}{\partial x} ) dy ] \cdot \frac{{\int }_{{y}_{L}}^{y} \vert {ω}_{0} \vert dy}{{\int }_{{y}_{L}}^{{y}_{U}} \vert {ω}_{0} \vert dy} \qquad ( 10 )$$

In step 42, the final azimuthal current velocity is determined according to the initial azimuthal current velocity and the ageostrophic current.

In a particular application example, the final azimuthal current velocity is determined by the following formula (11):

v=v₀+δv (11)
where v represents the final azimuthal current velocity; v₀ represents the initial azimuthal current velocity; and δv represents the ageostrophic current.

In step 205, an ocean surface vector current field is reconstructed according to the radial ocean surface current velocity and the final azimuthal current velocity so as to obtain a current velocity magnitude and a current direction of the reconstructed ocean surface vector current field.

In a particular application example, the radial ocean surface current velocity and the final azimuthal current velocity are projected into an east-west vertical coordinate system and a north-south vertical coordinate system, respectively, to obtain an east-west component and a north-south component of ocean surface currents.

The ocean surface vector current field is reconstructed according to the radial ocean surface current velocity and the final azimuthal current velocity using formulas U=\sqrt{u_{E}²+v_{N}²} and

$$Φ = arc tan \frac{{u}_{E}}{{v}_{N}}$$

so as to obtain the current velocity magnitude and the current direction of the reconstructed ocean surface vector current field, where U represents the current velocity magnitude of the reconstructed ocean surface vector current field; Φ represents the current direction of the reconstructed ocean surface vector current field; u_{E} represents the east-west component; and v_{N} represents the north-south component.

The ocean surface vector current field reconstructed from the radial ocean surface current velocity observed by the SAR can be utilized by operational ocean forecasting agencies and relevant departments such as those of satellite remote sensing.

In the present application, based on the geostrophic assumption for mesoscale ocean currents (i.e., zero divergence of the ocean currents), the initial azimuthal current velocity is estimated first with the known radial ocean surface current velocity by solving the divergence equation. Next, ageostrophic correction is performed on the initial azimuthal current velocity using the surface horizontal momentum equation to obtain a more accurate azimuthal current velocity. Finally, vector synthesis is performed on the radial ocean surface current velocity and the final azimuthal current velocity to obtain the complete ocean surface vector current field.

The present application takes full advantage of the physical oceanography theory. By neglecting terms of smaller orders and employing the adjustment parameter to simplify the equation, the formula for calculating an azimuthal current velocity is derived. This formula integrates both geostrophic approximation and ageostrophic correction. It is noteworthy that relying solely on the initial azimuthal current velocity results in numerous inaccurate ocean current estimations, such as underestimation in high-value regions and overestimation in low-value regions. However, after performing the ageostrophic correction, the results are significantly improved, with the root mean square error reduced to about 0.2 m/s. The synergistic action of step 203 and step 204 allows for accurately obtaining the ocean surface vector current field from the single-antenna SAR, with a spatial resolution of up to 1 km. The method provided by the present application offers more accurate and comprehensive ocean current data support for research on oceanic circulation, environmental monitoring, disaster warning, and enhancing the forecasting accuracy of ocean numerical models.

Based on the same inventive concept, an embodiment of the present application further provides a device for reconstructing ocean surface vector currents based on a spaceborne synthetic aperture radar to implement the above-mentioned method for reconstructing ocean surface vector currents based on a spaceborne synthetic aperture radar. The implementation solutions provided by the device to problems are similar to those described in the aforesaid method. Thus, for specific definitions in one or more embodiments of the device for reconstructing ocean surface vector currents based on a spaceborne synthetic aperture radar, reference may be made to those provided above in the method for reconstructing ocean surface vector currents based on a spaceborne synthetic aperture radar, which will not be described here redundantly.

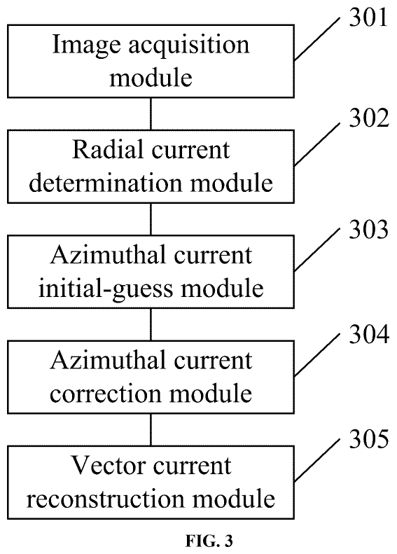

In an exemplary embodiment, as shown in FIG. 3, provided is a device for reconstructing ocean surface vector currents based on a spaceborne synthetic aperture radar. The device includes an image acquisition module 301, a radial current determination module 302, an azimuthal current initial-guess module 303, an azimuthal current correction module 304, and a vector current reconstruction module 305.

The image acquisition module 301 is configured to acquire a synthetic aperture radar image of a research region.

The radial current determination module 302 is configured to determine a radial ocean surface current velocity according to the synthetic aperture radar image.

The azimuthal current initial-guess module 303 is configured to determine an initial azimuthal current velocity based on a geostrophic approximation theory and the radial ocean surface current velocity.

The azimuthal current correction module 304 is configured to perform ageostrophic correction on the initial azimuthal current velocity to obtain a final azimuthal current velocity.

The vector current reconstruction module 305 is configured to reconstruct an ocean surface vector current field according to the radial ocean surface current velocity and the final azimuthal current velocity so as to obtain a current velocity magnitude and a current direction of the reconstructed ocean surface vector current field.

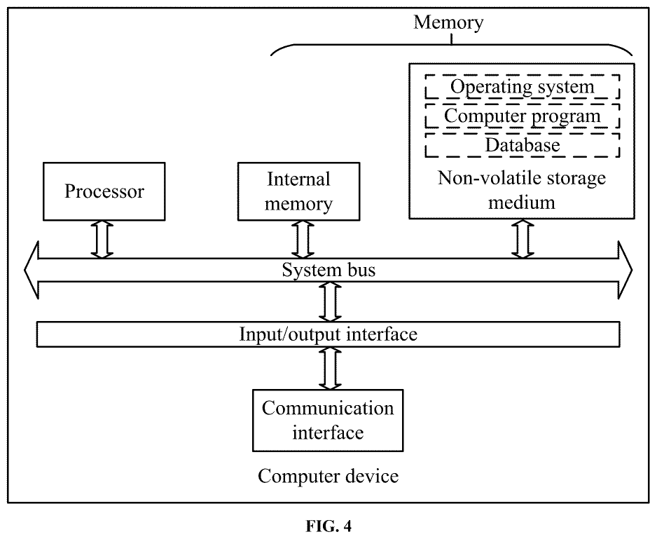

In an exemplary embodiment, provided is a computer device, which may be a server or a terminal, and an internal structure thereof may be as shown in FIG. 4. The computer device includes a processor, a memory, an input/output interface (I/O), and a communication interface. The processor, the memory, and the input/output interface are connected via a system bus, and the communication interface is connected to the system bus via the input/output interface. The processor of the computer device is configured to provide computing and control capabilities. The memory of the computer device includes a nonvolatile storage medium and an internal memory. The non-volatile storage medium stores an operating system, a computer program, and a database. The internal memory provides an environment for operation of the operating system and the computer program in the nonvolatile storage medium. The database of the computer device is configured to store a synthetic aperture radar image of a research region. The input/output interface of the computer device is configured to exchange information between the processor and an external device. The communication interface of the computer device is configured to communicate with an external terminal through a network. The computer program, when executed by the processor, causes a method for reconstructing ocean surface vector currents based on a spaceborne synthetic aperture radar to be implemented.

Those person skilled in the art may understand that the structure shown in FIG. 4 is only a block diagram of a part of the structure related to the solution of the present application and does not constitute a limitation on a computer device to which the solution of the present application is applied. Specifically, the computer device may include more or less components than those shown in the figure, or combine some components, or have different component arrangements.

In an exemplary embodiment, provided is a computer-readable storage medium, storing a computer program which, when executed by a processor, implements the steps in the above method embodiments.

In an exemplary embodiment, provided is a computer program product, including a computer program which, when executed by a processor, implements the steps in the above method embodiments.

It is to be noted that user information (including, but not limited to, user device information, user personal information, and the like) and data (including, but not limited to, data for analysis, data for storage, data for presentation, and the like) involved in the present application are information and data authorized by the user or fully authorized by each party, and relevant data shall be collected, used, and processed according to the related regulations.

In the present application, the signals, information, or data are acquired in compliance with the relevant data protection regulations and policies of the respective country with the authorization of the respective device owner.

Those person of ordinary skill in the art may understand that all or some of the procedures in the methods of the above embodiments may be implemented by a computer program instructing related hardware. The computer program may be stored in a nonvolatile computer-readable storage medium. When the computer program is executed, the procedures in the embodiments of the above methods may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present application may include at least one of a relational database and a non-relational database. The non-relational database may include a distributed database based on a blockchain, but is not limited thereto. The processor in the embodiments of the present application may be a general processor, a central processor, a graphics processor, a digital signal processor (DSP), a programmable logic device, and a data processing logic device based on quantum computing, but is not limited thereto.

The technical features of the above embodiments may be combined arbitrarily. For brevity of description, all the possible combinations of the technical features in the above embodiments are not described. However, as long as there is no contradiction between the combinations of these technical features, they shall all fall within the scope of the specification.

Several examples are used herein for illustration of the principles and implementations of the present application. The description of the foregoing embodiments is used to help illustrate the method of the present application and the core principles thereof. In addition, those of ordinary skill in the art can make various modifications in terms of specific implementations and scope of application in accordance with the teachings of the present application. In conclusion, the content of the present specification shall not be construed as a limitation to the present application.

What is claimed is:

1. A method for reconstructing ocean surface vector currents based on a spaceborne synthetic aperture radar, comprising:
acquiring a synthetic aperture radar image of a research region;
determining a radial ocean surface current velocity according to the synthetic aperture radar image;
determining an initial azimuthal current velocity based on a geostrophic approximation theory and the radial ocean surface current velocity;
performing ageostrophic correction on the initial azimuthal current velocity to obtain a final azimuthal current velocity, wherein the performing ageostrophic correction on the initial azimuthal current velocity to obtain a final azimuthal current velocity comprises: determining an ageostrophic current according to the initial azimuthal current velocity using a surface horizontal momentum equation; and determining the final azimuthal current velocity according to the initial azimuthal current velocity and the ageostrophic current; and the ageostrophic current is determined by a formula as follows:
$$δ v = [ ( {v}_{U} - {v}_{L} ) + {\int }_{{y}_{L}}^{{y}_{U}} ( \frac{\partial u}{\partial x} ) dy ] \cdot \frac{{\int }_{{y}_{L}}^{y} \vert {ω}_{0} \vert dy}{{\int }_{{y}_{L}}^{{y}_{U}} \vert {ω}_{0} \vert dy} ;$$
wherein δv represents the ageostrophic current; v_{U} represents an azimuthal current velocity at an upper ocean boundary in the synthetic aperture radar image; v_{L} represents an azimuthal current velocity at a lower ocean boundary in the synthetic aperture radar image; y_{U} represents a y-axis coordinate of the upper ocean boundary in the synthetic aperture radar image; y_{L} represents a y-axis coordinate of the lower ocean boundary in the synthetic aperture radar image; u represents the radial ocean surface current velocity; ω₀ represents a vorticity of ocean surface currents,
$${ω}_{0} = \frac{\partial }{\partial y} {v}_{L} ( x ) - \frac{\partial }{\partial y} u ( x , y ) - {\int }_{{y}_{L}}^{y} \frac{{\partial }^{2}}{\partial {x}^{2}} u ( x , y ) dy ;$$
v_{L}(x) represents an azimuthal current velocity at a position (x, y_{L}) along the lower ocean boundary in the synthetic aperture radar image; u(x, y) represents a radial ocean surface current velocity at a position (x, y); x and y represent coordinates in a rectangular coordinate system; and the x-axis represents a radial direction, while the y-axis represents an azimuthal direction; and
reconstructing an ocean surface vector current field according to the radial ocean surface current velocity and the final azimuthal current velocity so as to obtain a current velocity magnitude and a current direction of the reconstructed ocean surface vector current field.

2. The method for reconstructing ocean surface vector currents based on a spaceborne synthetic aperture radar according to claim 1, wherein the synthetic aperture radar image comprises Doppler shifts of an ocean surface; and
the determining a radial ocean surface current velocity according to the synthetic aperture radar image comprises:
correcting a non-geophysical Doppler shift and wave motion-induced Doppler shift among the Doppler shifts of the ocean surface to obtain an ocean current-induced Doppler shift; and
determining the radial ocean surface current velocity by a formula
$$u = - \frac{π {f}_{o s c}}{{k}_{r} sin ( θ )}$$
according to the ocean current-induced Doppler shift, wherein u represents the radial ocean surface current velocity; f_{osc} represents the ocean current-induced Doppler shift; kᵣ represents a wavenumber of an incident electromagnetic wave; and θ represents a radar incidence angle.

3. The method for reconstructing ocean surface vector currents based on a spaceborne synthetic aperture radar according to claim 1, wherein the initial azimuthal current velocity is determined by a formula below:
$${v}_{0} = {v}_{L} - {\int }_{{y}_{L}}^{y} \frac{\partial u}{\partial x} dy ;$$
wherein v₀ represents the initial azimuthal current velocity; v_{L} represents an azimuthal current velocity at a lower ocean boundary in the synthetic aperture radar image; y_{L} represents a y-axis coordinate of the lower ocean boundary in the synthetic aperture radar image; u represents the radial ocean surface current velocity; x and y represent coordinates in a rectangular coordinate system; and the x-axis represents a radial direction, while the y-axis represents an azimuthal direction.

4. The method for reconstructing ocean surface vector currents based on a spaceborne synthetic aperture radar according to claim 1, wherein the final azimuthal current velocity is determined by a formula below:
v=v₀+δv;
wherein v represents the final azimuthal current velocity; v₀ represents the initial azimuthal current velocity; and δv represents the ageostrophic current.

5. The method for reconstructing ocean surface vector currents based on a spaceborne synthetic aperture radar according to claim 1, wherein the reconstructing an ocean surface vector current field according to the radial ocean surface current velocity and the final azimuthal current velocity comprises:
projecting the radial ocean surface current velocity and the final azimuthal current velocity into an east-west vertical coordinate system and a north-south vertical coordinate system, respectively, to obtain an east-west component and a north-south component of the ocean surface currents; and
reconstructing the ocean surface vector current field according to the radial ocean surface current velocity and the final azimuthal current velocity using formulas U=\sqrt{u_{E}²+v_{N}²} and
$$Φ = arc tan \frac{{u}_{E}}{{v}_{N}}$$
so as to obtain the current velocity magnitude and the current direction of the reconstructed ocean surface vector current field, wherein U represents the current velocity magnitude of the reconstructed ocean surface vector current field; Φ represents the current direction of the reconstructed ocean surface vector current field; u_{E} represents the east-west component; and v_{N} represents the north-south component.
